(19) United States
(12) Patent Application Publication
(10) Pub. No.: US 2026/0277476 A1
(43) Pub. Date: Sep. 17, 2026

(54) INPUT QUEUE MASKS FOR PROCESSING COMMANDS

(71) Applicant: Micron Technology, Inc., Boise, ID (US)

(72) Inventor: Hua Ye, San Jose, CA (US)

(21) Appl. No.: 19/077,191

(22) Filed: Mar. 12, 2025

(51) Int. Cl. G06F 3/06

(52) U.S. Cl. CPC G06F 3/0659; G06F 3/0611; G06F 3/0673

(57) ABSTRACT

Methods, systems, and devices for input queue masks for processing commands are described. The memory system may implement a bitmask to indicate which input command queues include commands and are associated with credited QoS scheduling table entries. For example, a logical operation may be performed on a bitmask indicating which entries of a QoS scheduling table include credits and a bitmask indicating which of the input command queues of the memory system store commands. The results of the logical operation may indicate which of the input queues store commands and are associated with an allocation credit. Rather than accessing each input command queue associated with credited QoS scheduling entries, the memory system may access input command queues indicated by the result of the logical operation.

### TECHNICAL FIELD

The following relates to one or more systems for memory, including input queue masks for processing commands.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports input queue masks for processing commands in accordance with examples as disclosed herein.

FIG. 2 shows an example of a system that supports input queue masks for processing commands in accordance with examples as disclosed herein.

FIG. 3 shows an example of a process that supports input queue masks for processing commands in accordance with examples as disclosed herein.

FIG. 4 shows a block diagram of a memory system that supports input queue masks for processing commands in accordance with examples as disclosed herein.

FIG. 5 shows a flowchart illustrating a method or methods that support input queue masks for processing commands in accordance with examples as disclosed herein.

### DETAILED DESCRIPTION

Some memory systems may implement various quality of service (QoS) operations to control the flow of commands and data between a host system and the memory system. When performing QoS operations, a memory system may assign credits to a QoS scheduling entry. If a scheduling entry's assigned credits are greater than a threshold (e.g., if credits are non-zero), a corresponding command input queue may be checked for a command (e.g., an I/O command) to process. In some instances, the command input queue may include one or more commands for processing and, in such instances, the command(s) may be processed and the QoS scheduling entry credits may be decreased. However, in other examples, the command input queue may be empty. Accordingly, the memory system may monitor both a QoS scheduling entry (e.g., for credits) and an associated input queue (e.g., for commands) regardless of whether the input queue includes any commands, which may negatively affect the system's overall performance. Additionally, or alternatively, in the case that the memory system may include a large quantity of empty command input queues, the memory system may incur additional latency when monitoring the queues for commands to process.

The memory system described herein may implement a bitmask to indicate which input command queues include commands and are associated with credited QoS scheduling entries, which may improve system performance and mitigate latency that would otherwise be incurred. For example, a logical operation (e.g., a logical AND operation) may be performed on a bitmask indicating which QoS scheduling entries include credits and a bitmask indicating which of the input command queues of the memory system store commands. The results of the logical operation may be an example of (e.g., be formatted as) a scheduling bitmask that indicates which of the input queues store commands and are associated with one or more credits. Rather than accessing each input command queue associated with credited QoS scheduling entries (e.g., regardless of whether the input command queue holds commands), the memory system may access input command queues indicated by the final scheduling bitmask as storing commands and being associated with credited QoS scheduling entries, which may improve the system's overall efficiency and performance while decreasing latency that would otherwise be incurred due to monitoring each input command queue.

In addition to applicability in memory systems as described herein, use of input queue masks for processing commands may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems as described herein, use of input queue masks for processing commands may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by decreasing accesses of a memory system which may extend the life of electronic devices and thereby reducing electronic waste, among other benefits.

Features of the disclosure are illustrated and described in the context of systems, devices, and circuits. Features of the disclosure are further illustrated and described in the context of processes and flowcharts.

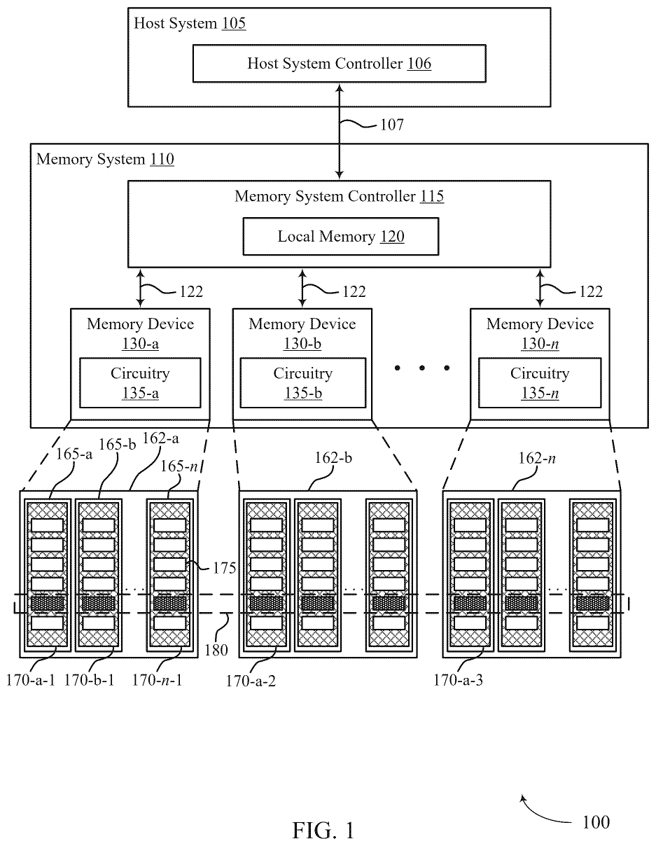

FIG. 1 shows an example of a system 100 that supports input queue masks for processing commands in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-n, where n represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-n may include circuitry 135-n.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include n planes 165 and each plane may include m blocks 170, where n and m represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-n, where n represents an Nth plane. The memory die 162-b and the memory die 162-n may also include N planes. In some cases, an individual block 170 may be referred to as a physical block, and a virtual block 180 may refer to a group of physical blocks 170 within which concurrent operations may occur. A virtual block 180 may be a logical structure that includes a plurality of blocks, where different blocks of the plurality of blocks may come from different planes 165 or different memory dies 162. In some cases, a virtual block may include blocks 170 from different memory devices 130 (e.g., including blocks in one or more planes 165 of memory device 130-a, memory device 130-b, and memory device 130-n). In some examples, a virtual block may include a respective block from each plane 165 (e.g., a block 170 from each plane 165) of one or more memory dies 162.

In some cases, the blocks 170 within a virtual block may have the same block address within their respective planes 165. For example, block 170-a-1 may be “block 0 ” of a first plane of die 162-a, block 170-a-2 may be “block 0 ” of a first plane of die 162-b, block 170-a-3 may be “block 0 ” of a first plane of die 162-n, and so on. By way of further example, block 170-b-1 may be “block 1” of a first plane of die 162-a and block 170-n-1 may be “block n” of die 162-a, where n represents an Nth block. The memory die 162-b and the memory die 162-n may also include N blocks. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In some cases, to update some data within a block 170 while retaining other data within the block 170, the memory device 130 may write the updated data to a new block 170. The memory device 130 (e.g., circuitry 135) or the memory system controller 115 may mark or otherwise designate the addresses of the data that was updated in the block 170 as invalid or obsolete and may update a logical-to-physical (L2P) mapping table to associate the logical address (e.g., LBA) for the data with the new block 170 rather than the original block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by circuitry 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or circuitry 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The memory system 110 may implement various QoS operations to control the flow of commands and data between a host system 105 and the memory system 110. When performing QoS operations, the memory system 110 may assign credits to a QoS scheduling entry. If a scheduling entry's credit is greater than a threshold (e.g., if the quantity of credits is greater than zero), a command input queue may be checked for a command (e.g., an I/O command) to process. In some instances, the command input queue may include one or more commands for processing and, in such instances, the command(s) may be processed and the QoS scheduling entry credits may be decreased. However, in other examples, the command input queue may be empty. Accordingly, the memory system may monitor both a QoS scheduling entry (e.g., for credits) and an associated input queue (e.g., for commands) regardless of whether the input queue includes any commands, which negatively affect system performance. Additionally, or alternatively, in the case that the memory system 110 may include a large quantity of empty command input queues, the memory system 110 may incur additional latency when checking such queues for commands to process.

The memory system 110 may implement a bitmask to indicate which input command queues include commands and are associated with credited QoS scheduling entries, which may improve system performance and mitigate latency that would otherwise be incurred. For example, a logical operation (e.g., a logical AND operation) may be performed on a bitmask indicating which QoS scheduling entries include credits and a bitmask indicating which of the input command queues of the memory system 110 store commands. The results of the logical operation may be an example of or otherwise be referred to a scheduling bitmask that indicates which of the input queues both store commands and are associated with an allocation credit. Rather than accessing each input command queue associated with credited QoS scheduling entries (e.g., regardless of whether the input command queue holds commands), the memory system 110 may access input command queues indicated by the final scheduling bitmask as storing commands and being associated with credited QoS scheduling entries, which may decrease access operations at the memory system 110 and thus increase performance of the memory system 110.

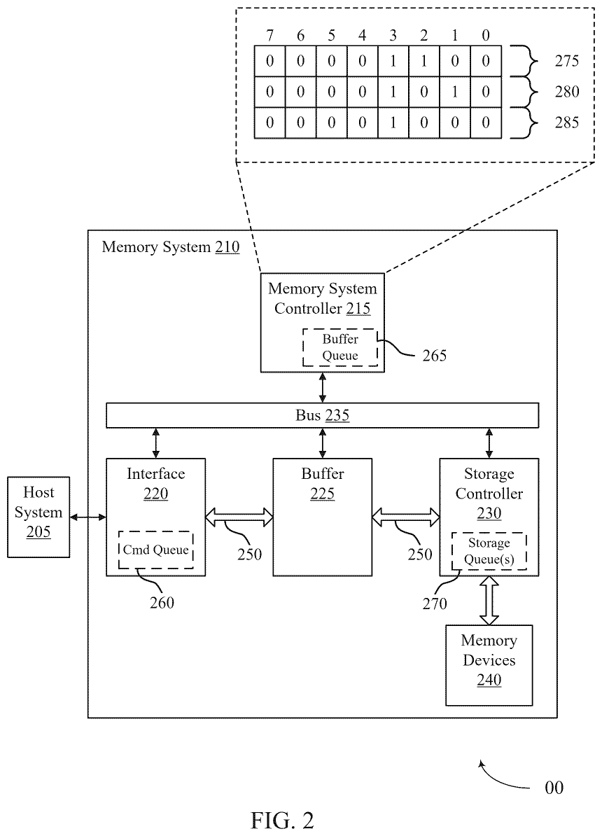

FIG. 2 shows an example of a system 200 that supports input queue masks for processing commands in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of the circuitry 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, one or more storage queues 270) may be used to control the processing of access commands and the movement of corresponding data. This may be beneficial, for example, if more than one access command from the host system 205 is processed concurrently by the memory system 210. The command queue 260, the buffer queue 265, and the storage queues 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, one or more storage queues 270 (e.g., one or more command input queues) may support a transfer of write data. For example, the memory system controller 215 may push (e.g., via the bus 235) write commands from the buffer queue 265 to one or more of the storage queues 270 for processing. The storage queues 270 may include entries for each access command. In some examples, the storage queues 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queues 270) the location within the buffer 225 from which to obtain the data. The storage controller 230 may manage the locations within the memory devices 240 to store the data (e.g., performing wear-leveling, performing garbage collection). The entries may be added to the storage queues 270 (e.g., by the memory system controller 215). The entries may be removed from the storage queues 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queues 270 may be used to aid with the transfer of read data. For example, the memory system controller 215 may push the read command to the storage queues 270 for processing. In some cases, the storage controller 230 may obtain (e.g., from the buffer 225, from the storage queues 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queues 270) the location within the buffer 225 to store the data. In some cases, the memory system controller 215 may move the command processed by the storage queues 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

The memory system 210 may implement various QoS operations to control the flow of commands and data between the host system 205 and the memory devices 240. For example, the memory system 210 may be unable to perform multiple operations associated received commands at once, and may thus implement a round-robin scheduling technique in which the memory system 210 may implement a credit system to stagger and prioritize the performance of operations associated with incoming commands. In some examples, the memory system 210 may assign credits to entries of a scheduling bitmask table 275 according to indications received by the host system 205 or a pre-processing I/O core. In some other examples, the memory system controller 215 may assign credits to entries of the scheduling bitmask table 275 associated with relatively high-priority operations which may correspond to entries (e.g., pending commands) of the one or more storage queues 270. Each credit may be an example of a value (e.g., a “1”) that may indicate to the memory system 210 that the corresponding entry of the storage queues 270 is able to be processed.

During each iteration of the QoS operation, the memory system controller 215 may check the entries of the scheduling bitmask table 275 (e.g., for one or more credits) to determine whether to check the associated storage queue 270 for a pending command. In the case that the memory system controller 215 detects a credit in an entry of the scheduling bitmask table 275, the memory system controller 215 may access the associated entry of the storage queues 270 and check for a pending command. In some examples, the associated entry of the storage queues 270 may include a command and the memory system controller 215 may process the command (e.g., “pop” the command and prepare to perform an operation associated with the command). In response to processing the command, the memory system controller 215 may reset the entry of the scheduling bitmask table 275 by setting the value to “0”.

The memory system controller 215 may continue to check the entries of the scheduling bitmask table 275 and access the associated entries of the storage queues 270 regardless of whether the storage queues 270 store a pending command. For example, if an entry of the scheduling bitmask table 275 includes a credit, the memory system controller 215 may access the associated entry of the storage queues 270 even if the entry does not store a command. In some examples, the memory system controller 215 may check one or more storage queues 270 for commands in response to determining the associated entries of the scheduling bitmask table 275 includes a threshold quantity of credits, which may negatively affect system performance.

To decrease the frequency at which storage queues 270 are unnecessarily checked for commands, the memory system 210 may implement a storage queue bitmask table 280 and a calculated bitmask table 285 at the memory system controller 215. The storage queue bitmask table 280 may include one or more entries that may each be associated with a storage queue 270. The memory system controller 215 may store values in each entry of the storage queue bitmask table 280 that may be associated with a storage queue 270 that stores a pending command. For example, the memory system 210 may receive a command associated with an operation at the memory devices 240, and the memory system controller 215 may store the command in one of the storage queues 270. In response to storing the command, the memory system controller 215 may store a value (e.g., a “1”) in a corresponding entry of the storage queue bitmask table 280 to indicate that the storage queue 270 stores one or more commands. The memory system controller 215 may store a value in each entry of the storage queue bitmask table 280 for which a corresponding storage queue 270 stores a command. In response to processing a stored command, the memory system controller 215 may reset the associated entry of the storage queue bitmask table 280 by setting the value to “0”.

The calculated bitmask table 285 may include one or more entries associated with a separate storage queue 270 and may indicate which entries of the storage queues 270 store pending commands and are associated with entries of the scheduling bitmask table 275 that store credits. The memory system controller 215 may perform a logical operation using the values stored to the scheduling bitmask table 275 and the values stored to the storage queue bitmask table 280 to calculate respective values to store in each of the entries of the calculated bitmask table 285. For example, the memory system controller 215 may perform a logical AND operation using a value stored to an entry of the scheduling bitmask table 275 and a value stored to an entry of the storage queue bitmask table 280. In the case that the entry of the scheduling bitmask table 275 stores a threshold value (e.g., a value of “1”) and the associated entry of the storage queue bitmask table 280 stores a threshold value (e.g., a value of “1”), the result of the AND operation may be a value of “1” (e.g., as illustrated in entry “3”). In the case that corresponding entries of the scheduling bitmask table 275 and the storage queue bitmask table 280 may not both store values of “1,” the result of the AND operation may be a value of “0”. The memory system controller 215 may store the results of the AND operation to the entries of the calculated bitmask table 285 (e.g., as illustrated in entries “0 ” through “2” and “4” through “7”).

During each iteration of an operation at the memory system 210 (e.g., a QoS operation), the memory system controller 215 may access the entries of the calculated bitmask table 285. Rather than accessing each entry of the scheduling bitmask table 275, each entry of the storage queue bitmask table 280, and each of the storage queues 270, the memory system controller 215 may access the entries of the calculated bitmask table 285 to determine which of entries of the storage queues 270 store pending commands and are associated with entries of the scheduling bitmask table 275 that store credits. For example, the memory system controller 215 may determine that entry “3” of the calculated bitmask table 285 stores a value of “1,” which may indicate that entry “3” of the scheduling bitmask table 275 stores a credit (e.g., a value of “1”) and that the associated storage queue 270 stores pending commands. The memory system controller 215 may process the commands stored to the storage queue 270 associated with entry “3” of the calculated bitmask table 285 in response to determining that the entry “3” of the calculated bitmask table 285 store the threshold value.

Enabling the memory system controller 215 to access the calculated bitmask table 285 may decrease the frequency at which the memory system controller 215 checks empty storage queues 270 for commands, which may improve the system's overall latency and performance. For example, use of the calculated bitmask table 285 may allow the memory system 210 to access a single table when executing commands, rather than accessing entries of the scheduling bitmask table 275 and the storage queue bitmask table 280 or each of the storage queues 270. Decreasing such operations within the memory system 210 (e.g., at the storage queues 270) may increase the overall efficiency and performance of the memory system 210, while reducing latency that would otherwise be incurred by frequently checking empty storage queues 270 for commands.

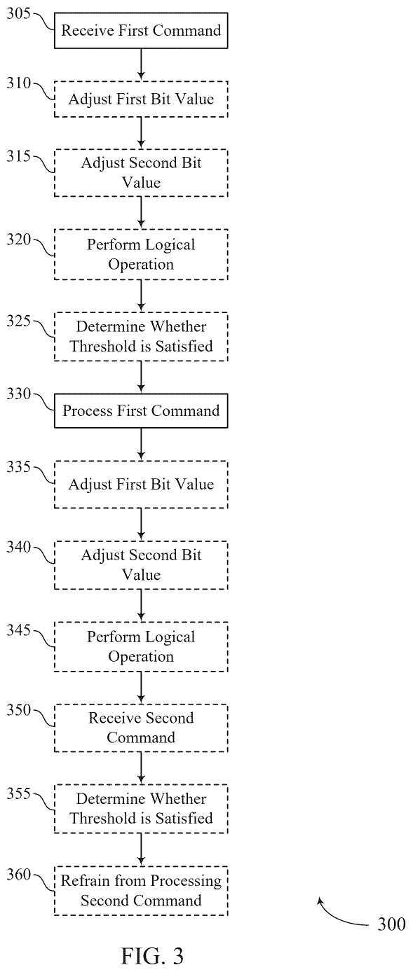

FIG. 3 shows an example of a process 300 that supports input queue masks for processing commands in accordance with examples as disclosed herein. The operations of process 300 may be performed by a memory system or one or more controllers associated with a memory system as described herein. For example, the operations of process 300 may be performed by a memory system 110, a memory system 210, or a controller thereof as described with reference to FIGS. 1 and 2. The process 300 may also include reference to a scheduling bitmask table, a storage queue bitmask table, a calculated bitmask table, and storage queues, which may be examples of a scheduling bitmask table 275, a storage queue bitmask table 280, a calculated bitmask table 285, and storage queues 270, respectively, as described with reference to FIG. 2.

At 305, a memory system may receive a first command at a first input queue (e.g., storage queue) of the memory system. The first input queue may be associated with a first bit value indicating whether the first input queue is associated with credits for processing one or more commands and a second bit value indicating whether the first input queue stores one or more commands.

At 310, a memory system controller may adjust the first bit value associated with the first input queue. For example, in response to receiving the first command, the memory system controller may update the first bit value to a value that satisfies a threshold value (e.g., a “1”). The memory system controller may adjust the first bit value at a first time. In some examples, the memory system controller may store the first bit value to a first table (e.g., a scheduling bitmask table) of the memory system in response to receiving the first command and adjusting the first bit value.

At 315, the memory system controller may adjust the second bit value associated with the first input queue. For example, in response to receiving the first command, the memory system controller may update the second bit value to a value that satisfies a threshold value (e.g., a “1”). The memory system controller may adjust the second bit value at a second time that may be different than the first time. In some examples, the memory system controller may store the second bit value to a second table (e.g., a storage queue bitmask table) of the memory system in response to receiving the first command and adjusting the second bit value.

At 320, the memory system controller may perform a logical operation. For example, the memory system controller may perform a logical AND operation on the first bit value and the second bit value to adjust a third bit value to a value that satisfies the threshold value (e.g., a “1”). The adjusted third bit value may indicate that the first input queue is associated with credits for processing one or more commands and stores one or more commands. In some examples, the memory system controller may store the third bit value to a third table (e.g., a calculated bitmask table) of the memory system in response to receiving the first command and adjusting the third bit value, and in accordance with storing the first bit value and the second bit value to the first and second tables, respectively.

At 325, the memory system controller may determine whether the threshold value is satisfied. For example, the memory system may access the third table, and may determine whether the third bit value satisfies the threshold value. In some examples, the threshold value may be an example of a value of “1,” and may indicate that the first bit value and the second bit value are both “1” (e.g., that both the first bit value and the second bit value satisfy the threshold value).

At 330, the memory system controller may process the received first command. For example, in response to determining that the third bit value satisfies the threshold value, the memory system controller may process the first command received at the first input queue. In some examples, processing the first command may include the memory system controller preparing to perform operations associated with the first command.

At 335, the memory system controller may adjust the first bit value associated with the first input queue. For example, in response to processing the first command, the memory system controller may update the first bit value to a value that fails to satisfy the threshold value (e.g., “0”). The memory system controller may store the first bit value to the first table (e.g., the scheduling bitmask table) of the memory system in response to processing the first command and adjusting the first bit value.

At 340, the memory system controller may adjust the second bit value associated with the first input queue. For example, in response to processing the first command, the memory system controller may update the second bit value to a value that fails to satisfy the threshold value (e.g., “0”). The memory system controller may store the second bit value to a second table (e.g., the storage queue bitmask table) of the memory system in response to processing the first command and adjusting the second bit value.

At 345, the memory system controller may perform the logical operation. For example, the memory system controller may perform the logical AND operation on the first bit value and the second bit value again to adjust the third bit value to a value that fails to satisfy the threshold value (e.g., “0”). The adjusted third bit value may indicate that the first input queue may not be associated with credits for processing one or more commands, may not store one or more commands, or a combination thereof. In some examples, the memory system controller may store the third bit value to the third table (e.g., the calculated bitmask table) of the memory system in response to processing the first command and adjusting the third bit value, and in accordance with storing the first bit value and the second bit value to the first and second tables, respectively.

At 350, the memory system controller may receive a second command at a second input queue (e.g., storage queue) of the memory system. The second input queue may be associated with a respective first bit value of the first table indicating whether the second input queue is associated with credits for processing one or more commands and a respective second bit value of the second table indicating whether the second input queue stores one or more commands. The memory system controller may continue to update the first bit value and the second bit value, and perform the logical operation to adjust a respective third bit value of the third table, in accordance with techniques described herein.

At 355, the memory system controller may determine whether the threshold value is satisfied. For example, the memory system may access the third table, and may determine whether the respective third bit value (e.g., associated with the second input queue) satisfies the threshold value.

At 360, the memory system controller may refrain from processing the received second command. For example, in response to determining that the respective third bit value fails to satisfy the threshold value, the memory system controller may refrain from processing the second command received at the second input queue. In some examples, the third bit value may be an example of a “0 ,” which may indicate that the second input queue may not be associated with credits for processing the second command (e.g., as the second the second command was received at the second input queue).

The memory system controller may continue the processes described with reference to FIG. 3. For example, the memory system controller may receive one or more other commands at a quantity of input queues of the memory system. The memory system controller may adjust respective first and second bit values associated with the various input queues, may perform logical operations using the respective first and second bit values to calculate respective third bit values, and may process the commands received at the input queues associated with respective third bit values that satisfy the threshold value.

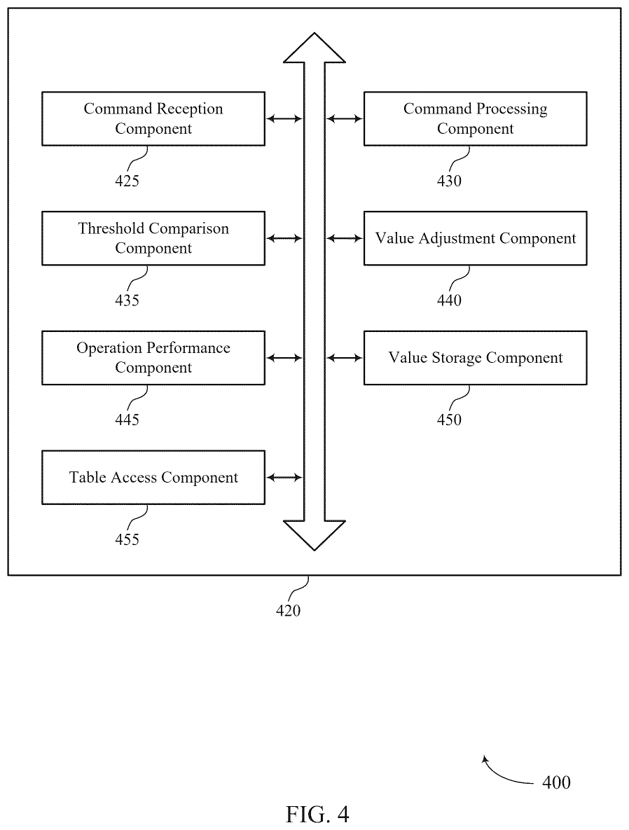

FIG. 4 shows a block diagram 400 of a memory system 420 that supports input queue masks for processing commands in accordance with examples as disclosed herein. The memory system 420 may be an example of aspects of a memory system as described with reference to FIGS. 1 through 3. The memory system 420, or various components thereof, may be an example of means for performing various aspects of input queue masks for processing commands as described herein. For example, the memory system 420 may include a command reception component 425, a command processing component 430, a threshold comparison component 435, a value adjustment component 440, an operation performance component 445, a value storage component 450, a table access component 455, or any combination thereof. Each of these components, or components of subcomponents thereof (e.g., one or more processors, one or more memories), may communicate, directly or indirectly, with one another (e.g., via one or more buses).

The command reception component 425 may be configured as or otherwise support a means for receiving a first command at a first input queue of the memory system, the first input queue associated with a first bit value indicating whether the first input queue includes credits for processing one or more commands and a second bit value indicating whether the first input queue includes one or more commands. The command processing component 430 may be configured as or otherwise support a means for processing the first command based at least in part on whether a third bit value associated with the first input queue satisfies a threshold value, the third bit value based at least in part on performing a logical operation on the first bit value and the second bit value.

In some examples, the memory system includes a plurality of input queues each associated with a respective first bit value, and the command reception component 425 may be configured as or otherwise support a means for receiving a second command at a second input queue of the memory system. In some examples, the memory system includes a plurality of input queues each associated with a respective first bit value, and the threshold comparison component 435 may be configured as or otherwise support a means for determining, based at least in part on receiving the second command, whether a respective third bit value associated with the second input queue satisfies the threshold value. In some examples, the memory system includes a plurality of input queues each associated with a respective first bit value, and the command processing component 430 may be configured as or otherwise support a means for refraining from processing the second command based at least in part on determining that the respective third bit value associated with the second input queue fails to satisfy the threshold value.

In some examples, the value adjustment component 440 may be configured as or otherwise support a means for adjusting, at a first time, the first bit value to a value that satisfies the threshold value. In some examples, the operation performance component 445 may be configured as or otherwise support a means for performing the logical operation on the first bit value and the second bit value based at least in part on adjusting the first bit value at the first time, where the third bit value is adjusted to a value that satisfies the threshold value based at least in part on performing the logical operation on the first bit value and the second bit value.

In some examples, the value adjustment component 440 may be configured as or otherwise support a means for adjusting at least the first bit value associated with the first input queue based at least in part on processing the first command. In some examples, the operation performance component 445 may be configured as or otherwise support a means for performing the logical operation on the first bit value and the second bit value based at least in part on adjusting the first bit value, where the third bit value is adjusted to a value that fails to satisfy the threshold value based at least in part on performing the logical operation on the first bit value and the second bit value.

In some examples, the value adjustment component 440 may be configured as or otherwise support a means for adjusting, at a second time, the first bit value to the value that satisfies the threshold value. In some examples, the operation performance component 445 may be configured as or otherwise support a means for performing the logical operation on the first bit value and the second bit value based at least in part on adjusting the first bit value at the second time.

In some examples, the value adjustment component 440 may be configured as or otherwise support a means for adjusting at least the second bit value associated with the first input queue based at least in part on receiving the first command. In some examples, the operation performance component 445 may be configured as or otherwise support a means for performing the logical operation on the first bit value and the second bit value based at least in part on adjusting the second bit value, where the third bit value is adjusted to a value that satisfies the threshold value based at least in part on performing the logical operation on the first bit value and the second bit value.

In some examples, the value adjustment component 440 may be configured as or otherwise support a means for adjusting at least the second bit value associated with the first input queue based at least in part on processing the first command. In some examples, the operation performance component 445 may be configured as or otherwise support a means for performing the logical operation on the first bit value and the second bit value based at least in part on adjusting the second bit value, where the third bit value is adjusted to a value that fails to satisfy the threshold value based at least in part on performing the logical operation on the first bit value and the second bit value.

In some examples, the threshold value is satisfied based at least in part on the first bit value including a value that satisfies the threshold value and the second bit value including a value that satisfies the threshold value.

In some examples, the value storage component 450 may be configured as or otherwise support a means for storing the first bit value to a first table of the memory system based at least in part on receiving the first command. In some examples, the value storage component 450 may be configured as or otherwise support a means for storing the second bit value to a second table of the memory system. In some examples, the value storage component 450 may be configured as or otherwise support a means for storing the third bit value to a third table of the memory system in accordance with storing the first bit value to the first table and storing the second bit value to the second table. In some examples, the table access component 455 may be configured as or otherwise support a means for accessing the third table, where determining whether the third bit value associated with the first input queue satisfies the threshold value is based at least in part on accessing the third table.

In some examples, the command reception component 425 may be configured as or otherwise support a means for receiving a plurality of commands at respective input queues of a plurality of input queues of the memory system. In some examples, the threshold comparison component 435 may be configured as or otherwise support a means for determining, based at least in part on receiving the plurality of input queues, whether respective third bit values associated with the plurality of input queues satisfy the threshold value. In some examples, the command processing component 430 may be configured as or otherwise support a means for processing respective commands stored to input queues associated with a respective third bit value that satisfies the threshold value.

In some examples, the threshold comparison component 435 may be configured as or otherwise support a means for determining, based at least in part on receiving the first command, whether the third bit value associated with the first input queue satisfies the threshold value.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

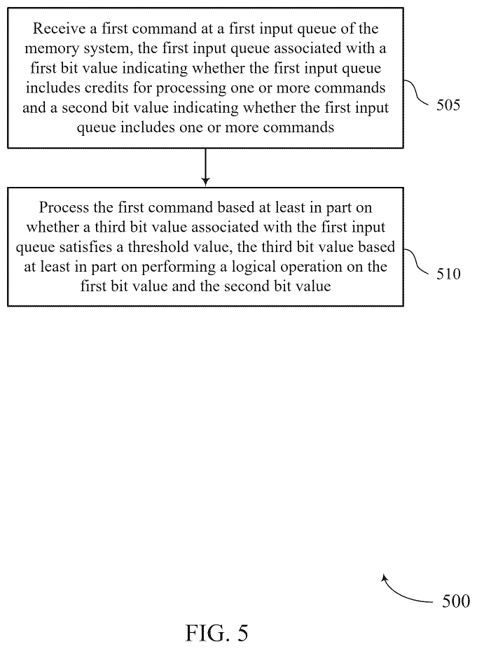

FIG. 5 shows a flowchart illustrating a method 500 that supports input queue masks for processing commands in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a first command at a first input queue of the memory system, the first input queue associated with a first bit value indicating whether the first input queue includes credits for processing one or more commands and a second bit value indicating whether the first input queue includes one or more commands. In some examples, aspects of the operations of 505 may be performed by a command reception component 425 as described with reference to FIG. 4.

At 510, the method may include processing the first command based at least in part on whether a third bit value associated with the first input queue satisfies a threshold value, the third bit value based at least in part on performing a logical operation on the first bit value and the second bit value. In some examples, aspects of the operations of 510 may be performed by a command processing component 430 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first command at a first input queue of the memory system, the first input queue associated with a first bit value indicating whether the first input queue includes credits for processing one or more commands and a second bit value indicating whether the first input queue includes one or more commands and processing the first command based at least in part on whether a third bit value associated with the first input queue satisfies a threshold value, the third bit value based at least in part on performing a logical operation on the first bit value and the second bit value.

Aspect 2: The method, apparatus, or non-transitory computer-readable medium of aspect 1, where the memory system includes a plurality of input queues each associated with a respective first bit value and the method, apparatuses, and non-transitory computer-readable medium further includes operations, features, circuitry, logic, means, or instructions, or any combination thereof for receiving a second command at a second input queue of the memory system; determining, based at least in part on receiving the second command, whether a respective third bit value associated with the second input queue satisfies the threshold value; and refraining from processing the second command based at least in part on determining that the respective third bit value associated with the second input queue fails to satisfy the threshold value.

Aspect 3: The method, apparatus, or non-transitory computer-readable medium of any of aspects 1 through 2, further including operations, features, circuitry, logic, means, or instructions, or any combination thereof for adjusting, at a first time, the first bit value to a value that satisfies the threshold value and performing the logical operation on the first bit value and the second bit value based at least in part on adjusting the first bit value at the first time, where the third bit value is adjusted to a value that satisfies the threshold value based at least in part on performing the logical operation on the first bit value and the second bit value.

Aspect 4: The method, apparatus, or non-transitory computer-readable medium of aspect 3, further including operations, features, circuitry, logic, means, or instructions, or any combination thereof for adjusting at least the first bit value associated with the first input queue based at least in part on processing the first command and performing the logical operation on the first bit value and the second bit value based at least in part on adjusting the first bit value, where the third bit value is adjusted to a value that fails to satisfy the threshold value based at least in part on performing the logical operation on the first bit value and the second bit value.

Aspect 5: The method, apparatus, or non-transitory computer-readable medium of aspect 4, further including operations, features, circuitry, logic, means, or instructions, or any combination thereof for adjusting, at a second time, the first bit value to the value that satisfies the threshold value and performing the logical operation on the first bit value and the second bit value based at least in part on adjusting the first bit value at the second time.

Aspect 6: The method, apparatus, or non-transitory computer-readable medium of any of aspects 1 through 5, further including operations, features, circuitry, logic, means, or instructions, or any combination thereof for adjusting at least the second bit value associated with the first input queue based at least in part on receiving the first command and performing the logical operation on the first bit value and the second bit value based at least in part on adjusting the second bit value, where the third bit value is adjusted to a value that satisfies the threshold value based at least in part on performing the logical operation on the first bit value and the second bit value.

Aspect 7: The method, apparatus, or non-transitory computer-readable medium of any of aspects 1 through 6, further including operations, features, circuitry, logic, means, or instructions, or any combination thereof for adjusting at least the second bit value associated with the first input queue based at least in part on processing the first command and performing the logical operation on the first bit value and the second bit value based at least in part on adjusting the second bit value, where the third bit value is adjusted to a value that fails to satisfy the threshold value based at least in part on performing the logical operation on the first bit value and the second bit value.

Aspect 8: The method, apparatus, or non-transitory computer-readable medium of any of aspects 1 through 7, where the threshold value is satisfied based at least in part on the first bit value including a value that satisfies the threshold value and the second bit value including a value that satisfies the threshold value.

Aspect 9: The method, apparatus, or non-transitory computer-readable medium of any of aspects 1 through 8, further including operations, features, circuitry, logic, means, or instructions, or any combination thereof for storing the first bit value to a first table of the memory system based at least in part on receiving the first command; storing the second bit value to a second table of the memory system; storing the third bit value to a third table of the memory system in accordance with storing the first bit value to the first table and storing the second bit value to the second table; and accessing the third table, where determining whether the third bit value associated with the first input queue satisfies the threshold value is based at least in part on accessing the third table.

Aspect 10: The method, apparatus, or non-transitory computer-readable medium of any of aspects 1 through 9, further including operations, features, circuitry, logic, means, or instructions, or any combination thereof for receiving a plurality of commands at respective input queues of a plurality of input queues of the memory system; determining, based at least in part on receiving the plurality of input queues, whether respective third bit values associated with the plurality of input queues satisfy the threshold value; and processing respective commands stored to input queues associated with a respective third bit value that satisfies the threshold value.

Aspect 11: The method, apparatus, or non-transitory computer-readable medium of any of aspects 1 through 10, further including operations, features, circuitry, logic, means, or instructions, or any combination thereof for determining, based at least in part on receiving the first command, whether the third bit value associated with the first input queue satisfies the threshold value.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a first command at a first input queue of the memory system, the first input queue associated with a first bit value indicating whether the first input queue comprises credits for processing one or more commands and a second bit value indicating whether the first input queue comprises one or more commands; and
process the first command based at least in part on whether a third bit value associated with the first input queue satisfies a threshold value, the third bit value based at least in part on performing a logical operation on the first bit value and the second bit value.

2. The memory system of claim 1, wherein the memory system comprises a plurality of input queues each associated with a respective first bit value, and the processing circuitry is further configured to cause the memory system to:
receive a second command at a second input queue of the memory system;
determine, based at least in part on receiving the second command, whether a respective third bit value associated with the second input queue satisfies the threshold value; and
refrain from processing the second command based at least in part on determining that the respective third bit value associated with the second input queue fails to satisfy the threshold value.

3. The memory system of claim 1, wherein the processing circuitry is further configured to cause the memory system to:
adjusting, at a first time, the first bit value to a value that satisfy the threshold value; and
perform the logical operation on the first bit value and the second bit value based at least in part on adjusting the first bit value at the first time, wherein the third bit value is adjusted to a value that satisfies the threshold value based at least in part on performing the logical operation on the first bit value and the second bit value.

4. The memory system of claim 3, wherein the processing circuitry is further configured to cause the memory system to:
adjust at least the first bit value associated with the first input queue based at least in part on processing the first command; and
perform the logical operation on the first bit value and the second bit value based at least in part on adjusting the first bit value, wherein the third bit value is adjusted to a value that fails to satisfy the threshold value based at least in part on performing the logical operation on the first bit value and the second bit value.

5. The memory system of claim 4, wherein the processing circuitry is further configured to cause the memory system to:
adjusting, at a second time, the first bit value to the value that satisfy the threshold value; and
perform the logical operation on the first bit value and the second bit value based at least in part on adjusting the first bit value at the second time.

6. The memory system of claim 1, wherein the processing circuitry is further configured to cause the memory system to:
adjust at least the second bit value associated with the first input queue based at least in part on receiving the first command; and
perform the logical operation on the first bit value and the second bit value based at least in part on adjusting the second bit value, wherein the third bit value is adjusted to a value that satisfies the threshold value based at least in part on performing the logical operation on the first bit value and the second bit value.

7. The memory system of claim 1, wherein the processing circuitry is further configured to cause the memory system to:
adjust at least the second bit value associated with the first input queue based at least in part on processing the first command; and
perform the logical operation on the first bit value and the second bit value based at least in part on adjusting the second bit value, wherein the third bit value is adjusted to a value that fails to satisfy the threshold value based at least in part on performing the logical operation on the first bit value and the second bit value.

8. The memory system of claim 1, wherein the threshold value is satisfied based at least in part on the first bit value comprising a value that satisfies the threshold value and the second bit value comprising a value that satisfies the threshold value.

9. The memory system of claim 1, wherein the processing circuitry is further configured to cause the memory system to:
store the first bit value to a first table of the memory system based at least in part on receiving the first command;
store the second bit value to a second table of the memory system;
store the third bit value to a third table of the memory system in accordance with storing the first bit value to the first table and storing the second bit value to the second table; and
access the third table, wherein determining whether the third bit value associated with the first input queue satisfies the threshold value is based at least in part on accessing the third table.

10. The memory system of claim 1, wherein the processing circuitry is further configured to cause the memory system to:
receive a plurality of commands at respective input queues of a plurality of input queues of the memory system;
determine, based at least in part on receiving the plurality of input queues, whether respective third bit values associated with the plurality of input queues satisfy the threshold value; and
process respective commands stored to input queues associated with a respective third bit value that satisfies the threshold value.

11. The memory system of claim 1, wherein the processing circuitry is further configured to cause the memory system to:
determine, based at least in part on receiving the first command, whether the third bit value associated with the first input queue satisfies the threshold value.

12. A method at a memory system, comprising:
receiving a first command at a first input queue of the memory system, the first input queue associated with a first bit value indicating whether the first input queue comprises credits for processing one or more commands and a second bit value indicating whether the first input queue comprises one or more commands; and
processing the first command based at least in part on whether a third bit value associated with the first input queue satisfies a threshold value, the third bit value based at least in part on performing a logical operation on the first bit value and the second bit value.

13. The method of claim 12, wherein the memory system comprises a plurality of input queues each associated with a respective first bit value, second bit value, and third bit value, the method further comprising:
receiving a second command at a second input queue of the memory system;
determining, based at least in part on receiving the second command, whether a respective third bit value associated with the second input queue satisfies the threshold value; and
refraining from processing the second command based at least in part on determining that the respective third bit value associated with the second input queue fails to satisfy the threshold value.

14. The method of claim 12, further comprising:
adjusting, at a first time, the first bit value to a value that satisfies the threshold value; and
performing the logical operation on the first bit value and the second bit value based at least in part on adjusting the first bit value at the first time, wherein the third bit value is adjusted to a value that satisfies the threshold value based at least in part on performing the logical operation on the first bit value and the second bit value.

15. The method of claim 14, further comprising:
adjusting at least the first bit value associated with the first input queue based at least in part on processing the first command; and
performing the logical operation on the first bit value and the second bit value based at least in part on adjusting the first bit value, wherein the third bit value is adjusted to a value that fails to satisfy the threshold value based at least in part on performing the logical operation on the first bit value and the second bit value.

16. The method of claim 15, further comprising:
adjusting, at a second time, the first bit value to the value that satisfies the threshold value; and
performing the logical operation on the first bit value and the second bit value based at least in part on adjusting the first bit value at the second time.

17. The method of claim 12, further comprising:
adjusting at least the second bit value associated with the first input queue based at least in part on receiving the first command; and
performing the logical operation on the first bit value and the second bit value based at least in part on adjusting the second bit value, wherein the third bit value is adjusted to a value that satisfies the threshold value based at least in part on performing the logical operation on the first bit value and the second bit value.

18. The method of claim 12, further comprising:
adjusting at least the second bit value associated with the first input queue based at least in part on processing the first command; and
performing the logical operation on the first bit value and the second bit value based at least in part on adjusting the second bit value, wherein the third bit value is adjusted to a value that fails to satisfy the threshold value based at least in part on performing the logical operation on the first bit value and the second bit value.

19. The method of claim 12, wherein the threshold value is satisfied based at least in part on the first bit value comprising a value that satisfies the threshold value and the second bit value comprising a value that satisfies the threshold value.

20. The method of claim 12, further comprising:
storing the first bit value to a first table of the memory system based at least in part on receiving the first command;
storing the second bit value to a second table of the memory system;
storing the third bit value to a third table of the memory system in accordance with storing the first bit value to the first table and storing the second bit value to the second table; and
accessing the third table, wherein determining whether the third bit value associated with the first input queue satisfies the threshold value is based at least in part on accessing the third table.

21. The method of claim 12, further comprising:
receiving a plurality of commands at respective input queues of a plurality of input queues of the memory system;
determining, based at least in part on receiving the plurality of input queues, whether respective third bit values associated with the plurality of input queues satisfy the threshold value; and
processing respective commands stored to input queues associated with a respective third bit value that satisfies the threshold value.

22. The method of claim 12, further comprising:
determining, based at least in part on receiving the first command, whether the third bit value associated with the first input queue satisfies the threshold value.

23. A non-transitory computer-readable medium storing code, the code comprising instructions executable by one or more processors to:
receive a first command at a first input queue of a memory system, the first input queue associated with a first bit value indicating whether the first input queue comprises credits for processing one or more commands and a second bit value indicating whether the first input queue comprises one or more commands; and
process the first command based at least in part on whether a third bit value associated with the first input queue satisfies a threshold value, the third bit value based at least in part on performing a logical operation on the first bit value and the second bit value.

24. The non-transitory computer-readable medium of claim 23, wherein the memory system comprises a plurality of input queues each associated with a respective first bit value, and the instructions are further executable by the one or more processors to:
receive a second command at a second input queue of the memory system;
determine, based at least in part on receiving the second command, whether a respective third bit value associated with the second input queue satisfies the threshold value; and
refrain from processing the second command based at least in part on determining that the respective third bit value associated with the second input queue fails to satisfy the threshold value.

25. The non-transitory computer-readable medium of claim 23, wherein the instructions are further executable by the one or more processors to:
adjusting, at a first time, the first bit value to a value that satisfy the threshold value; and
perform the logical operation on the first bit value and the second bit value based at least in part on adjusting the first bit value at the first time, wherein the third bit value is adjusted to a value that satisfies the threshold value based at least in part on performing the logical operation on the first bit value and the second bit value.
